(19) United States
(12) Patent Application Publication
(10) Pub. No.: US 2019/0075810 A1
(43) Pub. Date: Mar. 14, 2019

(54) ETHYL CELLULOSE OLEOGEL DISPERSION

(71) Applicant: DOW GLOBAL TECHNOLOGIES LLC, Midland, MI (US)

(72) Inventors: David L. Malotky, Midland, MI (US); Robert B. Appell, Midland, MI (US); Roja Ergun, Midland, MI (US)

(21) Appl. No.: 16/083,182

(22) PCT Filed: Mar. 27, 2017
(86) PCT No.: PCT/US2017/024267

§ 371 Date: Sep. 7, 2018

Related U.S. Application Data
(60) Provisional application No. 62/315,123, filed on Mar. 30, 2016.

(51) Int. Cl. A23D 7/005; A23L 29/262; A23L 29/00

(52) U.S. Cl. CPC A23D 7/005; A23L 29/262; A23L 29/04; A23V 2250/51088; A23V 2250/194; A23V 2250/1644; A23V 2002/00

(57) ABSTRACT

Provided is an aqueous dispersion comprising (a) 5% to 40% of a continuous phase, by weight based on the weight of the aqueous dispersion, wherein the continuous phase comprises 75% to 100% water, by weight based on the weight of the continuous phase, and (b) 60% to 95% of a distributed phase, by weight based on the weight of the aqueous dispersion, wherein the distributed phase comprises, by weight based on the weight of the distributed phase, (i) 2% to 20% ethylcellulose polymer (ii) 70% to 97% food oil (iii) 1% to 10% dispersant.

Fats that are solid at room temperature (23° C.) have been used in various food products for many years. Most solid fats contain an undesirably high proportion of saturated fats and/or trans fats, both of which have various nutritional disadvantages. It is desirable to replace the saturated fats and/or trans fats with unsaturated fats, which have various nutritional benefits. A common source of unsaturated fats is unsaturated oils such as vegetable oils, but these oils are typically liquid at room temperature or have melting points not far above room temperature. Simply replacing solid fat with liquid oil usually causes undesirable changes in the texture of the food product. It is desirable to replace the solid fat with a composition that is solid at room temperature and that contains unsaturated oil.

One approach to this problem has been the use of ethylcellulose oleogels, which are blends of oil or fat with a relatively small amount of ethylcellulose. Ethylcellulose oleogels can be solid at room temperature. In the course of developing the present invention it has been observed that ethylcellulose oleogels often have one or more of the following problems: they may be difficult to spread at room temperature; they sometimes separate into component ingredients during a shear process such as spreading or mixing; and they sometimes experience a major loss in firmness if subjected to mechanical shear at temperatures below the gel temperature. In the present invention, it has been discovered that an aqueous dispersion in which the dispersed particles contain ethylcellulose oleogel can be solid at room temperature and can avoid some or all of the problems that are sometimes observed with ordinary ethylcellulose oleogels.

U.S. Pat. No. 4,502,888 describes dispersions that contain particles dispersed in water, where the particles contain 50% or more ethylcellulose by weight. It is desired to provide an aqueous dispersion in which the dispersed particles contain 70% or more oil by weight.

The following is a statement of the invention.

A first aspect of the present invention is an aqueous dispersion comprising
(a) 5% to 40% of a continuous phase, by weight based on the weight of the aqueous dispersion, wherein the continuous phase comprises 75% to 100% water, by weight based on the weight of the continuous phase, and
(b) 60% to 95% of a distributed phase, by weight based on the weight of the aqueous dispersion, wherein the distributed phase comprises, by weight based on the weight of the distributed phase,
   (i) 2% to 20% ethylcellulose polymer
   (ii) 70% to 97% food oil
   (iii) 1% to 10% dispersant.

The following is a detailed description of the invention.

As used herein, the following terms have the designated definitions, unless the context clearly indicates otherwise.

As used herein, an aqueous composition has 15% or more water by weight based on the weight of the composition. As used herein, a dispersion is a composition that contains a continuous medium that is liquid at 25° C. The dispersion also contains discrete particles (herein called the “dispersed particles”) of a substance that are distributed throughout the continuous liquid medium. As used herein, an aqueous dispersion is an aqueous composition that is a dispersion in which the continuous liquid medium contains 75% or more water by weight based on the weight of the continuous liquid medium. Substances that are dissolved in the continuous liquid medium are considered herein to be part of the continuous liquid medium. The collection of all the dispersed particles is known herein as the “solid phase” of the dispersion. A dispersed particle is considered herein to contain both material located on the interior of the particle and material located on the surface of the particle, such as, for example, a dispersant.

As used herein, the “solids content” of an aqueous composition is the amount of material that remains when water and compounds having a boiling point of 200° C. or less have been removed. Solids content is characterized by weight percent based on the total weight of the aqueous composition.

Ethylcellulose polymer, as used herein, means a derivative of cellulose in which some of the hydroxyl groups on the repeating glucose units are converted into ethyl ether groups. The number of ethyl ether groups can vary. The number of ethyl ether groups is characterized by the “percent ethoxyl substitution.” The percent ethoxyl substitution is based on the weight of the substituted product and determined according to a Zeisel gas chromatographic technique as described in ASTM D4794-94 (2003). The USP monograph requirement for ethoxyl substitution (also called “ethyl ether content”) is from 44 to 51%.

As used herein, the viscosity of an ethylcellulose polymer is the viscosity of a 5 weight percent solution of that ethylcellulose polymer in a solvent, based on the weight of the solution. The solvent is a mixture of 80% toluene and 20% ethanol by weight. The viscosity of the solution is measured at 25° C. in an Ubbelohde viscometer.

As used herein, a fatty acid is a compound having a carboxyl group and a fatty group. A fatty group is a linear or branched chain of carbon atoms connected to each other that contains 4 or more carbon atoms. A hydrocarbon fatty group contains only carbon and hydrogen atoms. The term fatty acid is considered to include fatty acid compounds in which the carboxyl group is in the nonionic state as well as compounds in which the carboxyl group is in the anionic state.

A compound is considered herein to be water soluble if 2 grams or more of the compound will dissolve in 100 grams of water at 25° C. A compound is considered water soluble even if it is required to heat the water to a temperature higher than 25° C. in order to form the solution, as long as the solution of 2 grams or more of the compound in water is a stable solution at 25° C.

A “polymer,” as used herein is a relatively large molecule made up of the reaction products of smaller chemical repeat units. Polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. Polymers have weight-average molecular weight of 2,000 daltons or higher.

The softening point of a material is the temperature below which the material behaves as a solid and above which it begins to be capable of flow under mild to moderate stress. Softening point is measured by the ring and ball method according to ASTM E28-14.

As used herein, a base is a compound that has the ability to accept a proton to form the conjugate acid of that compound, and the conjugate acid of that compound has pKa of 7.5 or greater.

As used herein, an oil is a material that has melting point of 35° C. or less and that has one or more carbon atom per molecule. One category of oils is triglycerides, which are triesters of fatty acids with glycerol. Food oils are oils routinely consumed by human beings. Vegetable oils are triglycerides extracted from plants.

As used herein, an oleogel is a mixture of one or more oil and one or more ethylcellulose polymer that is solid at 25° C. The oleogel may be a relatively hard solid or a relatively soft solid. A cube of oleogel of height 2 cm, placed on a flat surface at 25° C., will resist collapsing under its own weight to the extent that the height after 1 minute will be 1 cm or higher.

An oleogel has a “gel temperature” that is determined as follows. Ethylcellulose polymer, oil, and optional additional ingredients, if any, are brought together at 23° C. and placed in a cylindrical metal cup of inner diameter 3 cm. A stirring propeller having vertical vanes and having diameter of 2 cm is introduced into the cup, coaxial with the axis of the cup, with the vanes covered by the mixture of ingredients. The cup is heated to a temperature above the softening point of the ethylcellulose polymer, and the propeller is rotated continuously. Sufficient stirring and heat are applied until the ethylcellulose dissolves in the oil. Then the solution is cooled at 2° C./min while the propeller is rotated at 500 rpm, and the torque on the propeller is monitored. As the temperature drops, the torque shows an increase in torque, where the torque increases by 2× or more in a temperature change of less than 10° C. The temperature of the onset of this sudden torque increase is the gel temperature.

As used herein, a dispersant is a surface-active material that assists solid particles distributed in a aqueous medium to remain distributed throughout the aqueous medium, with reduced tendency to settle to the bottom, rise to the top, or otherwise agglomerate. Dispersants include surfactants and polymeric electrolytes.

As used herein, a surfactant is a substance that has a molecule that includes both a hydrocarbon portion and a hydrophilic portion. The hydrocarbon portion contains 4 or more carbon atoms connected to each other in a formation that is linear, branched, cyclic, or a combination thereof. The hydrocarbon portion further contains one or more hydrogen atom. The hydrophilic portion would be soluble in water if it existed as a separate molecule, disconnected from the remainder of the surfactant molecule. Hydrophilic portions may be, for example, ionic groups or EO groups, which have the structure —(CH₂CH₂—O—)ₙ—, where n is 1 or higher. An ionic group is a group for which there is one or more value of pH between 4 and 12 at which, when plural ionic groups are in contact with water at that pH, 50 mole percent or more of the ionic groups will be in an ionized state.

Particles are spherical or nearly spherical. If a particle is not spherical, its diameter is taken herein to be the diameter of a sphere having the same volume. The diameters in a collection of particles is assessed by Vmean and D90. Vmean is the volume-average diameter. D90 is the diameter such that 90% of the particles by volume have diameter of D90 or smaller, while 10% or the particles by volume have diameter larger than D90.

Any ethylcellulose polymer may be used in the present invention. The ethoxyl substitution of the ethylcellulose polymer is 44% or more; preferably 47% or more; more preferably 48% or more. The ethoxyl substitution of the ethylcellulose polymer is 51% or less; preferably 50% or less.

The ethylcellulose polymer preferably has viscosity of 2 mPa-s or higher; more preferably 5 mPa-s or higher; more preferably 12 mPa-s or higher; more preferably 16 mPa-s or higher. The ethylcellulose polymer preferably has viscosity of 350 mPa-s or lower; more preferably 250 mPa-s or lower; more preferably 125 mPa-s or lower; more preferably 80 mPa-s or lower; more preferably 60 mPa-s or lower.

The ethylcellulose polymer preferably has softening point of 120° C. or higher; more preferably 130° C. or higher. The ethylcellulose polymer preferably has softening point of 160° C. or lower; more preferably 150° C. or lower; more preferably 140° C. or lower.

Commercially available forms of ethylcellulose polymer which may be used in the invention include, for example, those available under the name ETHOCEL™, from The Dow Chemical Company, including, for example, ETHOCEL™ Standard 4, ETHOCEL™ Standard 7, ETHOCEL™ Standard 10, ETHOCEL™ Standard 20, ETHOCEL™ Standard 45, or ETHOCEL™ Standard 100 with ethoxyl substitution from 48.0 to 49.5%. Other commercially available ethylcellulose polymers useful in embodiments of the invention include certain grades of AQUALON™ ETHYLCELLULOSE, available from Ashland, Inc., and certain grades of ASHACEL™ ethylcellulose polymers, available from Asha Cellulose Pvt. Ltd.

The present invention involves an aqueous dispersion. Preferably, the continuous liquid medium contains water in the amount, by weight based on the weight of the continuous liquid medium, of 80% or more; more preferably 90% or more.

Preferably, the distributed phase contains ethylcellulose polymer in an amount, by weight based on the total dry weight of the solid phase, of 4% or more; more preferably 6% or more; more preferably 8% or more. Preferably, the distributed phase in the aqueous dispersion contains ethylcellulose polymer in an amount, by weight based on the total dry weight of the solid phase, of 18% or less; more preferably 16% or less; more preferably 14% or less.

The distributed phase contains food oil. Preferred food oils are milk fat and vegetable oils; more preferred are vegetable oils. Preferred vegetable oils are cottonseed oil, peanut oil, coconut oil, linseed oil, palm kernel oil, rapeseed oil (also known as canola oil), palm oil, and mixtures thereof. Preferred vegetable oils are extracted from plant sources.

Preferably, the distributed phase contains food oil in an amount, by weight based on the total dry weight of the distributed phase, of 75% or more; more preferably 80% or more; more preferably 85% or more. Preferably, the distributed phase contains food oil in an amount, by weight based on the total dry weight of the distributed phase, of 95% or less; more preferably 93% or less; more preferably 91% or less.

The distributed phase contains dispersant. Preferred dispersants are surfactants. Preferred surfactants are fatty acids, esters of fatty acids, and combinations thereof. Preferred fatty acids have fatty groups containing 10 or more carbon atoms; more preferably 12 or more carbon atoms; more preferably 14 or more carbon atoms. Preferred fatty acids have fatty groups containing 20 or fewer carbon atoms. Among esters of fatty acids, preferred are those having structure R¹—C(O)—O—R² or R¹—C(O)—O—R³ where R¹ is a fatty group. R² is not a fatty group; R² contains a carboxyl group; and R² contains one or more oxygen atoms in addition to the carboxyl group. R³ is a group that contains one or more EO groups; preferably R³ contains two or more EO groups, and preferably the total number of —(CH₂—O—)— units in R³ is 10 or more. Preferred R¹ groups have 10 or more carbon atoms; more preferably 12 or more carbon atoms; more preferably 14 or more carbon atoms. Preferred R¹ groups have 20 or fewer carbon atoms.

Among esters of fatty acids having structure R¹—C(O)—O—R², preferred is sodium stearoyl lactylate. Among esters of fatty acids having structure R¹—C(O)—O—R³, preferred is polysorbate 80.

Preferred dispersants are fatty acids; more preferred are oleic acid and stearic acid; more preferred is stearic acid.

Among dispersants having a carboxyl group, preferred is the ionized form in which the associated cation is an alkali metal, preferably potassium.

Preferably, the distributed phase contains dispersant in an amount, by weight based on the total dry weight of the solid phase, of 1.5% or more; more preferably 2% or more; more preferable 2.5% or more; more preferably 3% or more. Preferably, the distributed phase contains dispersant in an amount, by weight based on the total dry weight of the solid phase, of 9% or less; more preferably 7% or less.

Preferably, the solids content of the aqueous dispersion of the present invention is, by weight based on the weight of the aqueous dispersion, 60% or more; more preferably 65% or more. Preferably, the solids content of the aqueous dispersion of the present invention is, by weight based on the weight of the aqueous dispersion, 95% or less; more preferably 90% or less.

Preferably, the particles in the aqueous dispersion of the present invention have Vmean of 0.1 μm or more; more preferably 0.2 μm or more. Preferably, the particles in the aqueous dispersion of the present invention have Vmean of 10 μm or less; more preferably 8 μm or less; more preferably 6 μm or less. Preferably, the particles in the aqueous dispersion of the present invention have D90 of 15 μm or less; more preferably 10 μm or less. Preferably, the particles in the aqueous dispersion of the present invention have D90 of 0.2 μm or more; more preferably 0.4 μm or more.

Preferably, the pH of the aqueous dispersion of the present invention is 8 or higher; more preferably 9 or higher. Preferably, the pH of the aqueous dispersion of the present invention is 13 or lower; more preferably 12 or lower.

The aqueous dispersion of the present invention may be made by any method. A preferred method is to make an oleogel of ethylcellulose polymer and food oil and to then make a dispersion of that oleogel in water using dispersant. The oleogel is preferably made by a process in which ethylcellulose polymer, food oil, and optional additional ingredients are mixed at a temperature above the softening point of the ethylcellulose polymer. A preferred method of making the oleogel involves extruding a mixture of ethylcellulose polymer and food oil, as described in WO 2014/193667. If optional additional ingredients are present during the making of the oleogel, preferred additional ingredients are dispersants, more preferably one or more surfactants. When the ethylcellulose polymer and the food oil are first brought into contact and mixed with each other, preferably no ingredients other than ethylcellulose polymer, food oil, and optional surfactant are present; more preferably no ingredients other than ethylcellulose polymer and food oil are present.

Oleogel may be mixed with water to form the aqueous dispersion of the present invention by any method that produces the desired dispersion. Preferably, a mixture of oleogel, water, and dispersant are agitated together at a temperature above the softening point of the ethylcellulose polymer. Preferably the temperature is greater than 135° C. A preferred method is to pass a mixture of the oleogel, water, and dispersant through a rotor stator mixer, preferably at a temperature above the softening point of the ethylcellulose polymer. It is contemplated that the mixture in the rotor stator mixer is maintained at pressure above 1 atmosphere. It is preferred that, prior to the mixture exiting the rotor stator mixer, the mixture is cooled below 100° C., so that as the mixture exits the rotor stator mixer, the water in the mixture is below its boiling point.

Other suitable methods of making the aqueous dispersion of the present invention are high internal phase emulsion (HIPE) methods such as those taught in U.S. Pat. No. 5,539,021 and single-stage high shear processes such as colloid mills or microfluidizers.

Additional ingredients may optionally be added to the oleogel. For example, an additive could be used that would lower the softening point of the ethylcellulose polymer in the oleogel, and that lower softening point would allow the oleogel to be turned into an aqueous dispersion using processes that were conducted at reduced temperature.

A preferred use for the aqueous dispersion of the present invention is as an ingredient in food formulations. The aqueous dispersion of the present invention is preferably used to replace some or all of the solid fat previously used in making baked goods. The solid fats that may be replaced are fats extracted from animals (such as, for example, butter or lard) and hydrogenated oils extracted from plants (such as, for example, margarine and hydrogenated cottonseed oil).

The following are examples of the present invention.

### PREPARATIVE EXAMPLE 1

### Making an Oleogel

Oleogel was made by a process described in WO 2014/193667, using an extruder. The extruder was a 25 mm diameter 36 L/D twin screw extruder equipped with a volumetric solids feeder. The extruder had 8 zones. Zones 1-7, and the head flange at the discharge of the extruder, were equipped with temperature control means. Zones 2, 4 and 6 were equipped with liquid injector ports as oil feed means. The extruder was equipped with a 0 to 6996 kPa (1,000) psig back pressure regulator, which was set at a pressure of from 446 to 1136 kPa (50 to 150 psig) at steady state extrusion conditions in order to ensure that the barrel of the extruder was full. Ethylcellulose was introduced into zone 0 via the volumetric solids feeder. The product exited the extruder from zone 7 through the head flange and back pressure regulator and continued onto a belt cooler where it was cooled to form the oleogel. Air flow was used to increase the cooling rate on the belt cooler.

Ethyl cellulose oleogels were made according to the following procedure. ETHOCEL™ Std. 45 (“EC1”) was fed to the extruder. Oil was metered into the extruder through the liquid injector ports at a variety of rates as shown in Table 1 (addition rates) and Table 2 (addition locations) to create a number of different oleogels. Table 1 also shows the weight percentage of ethylcellulose after each oil addition. The extruder temperature set point for each barrel segment, or zone, during production of these oleogels is also given in Table 2.

An oleogel was generated using the following process flow rates and temperature settings.

TABLE 1
Extruder Conditions

| | | EC1. | | Post 1st | | Post 2nd | | Final |
|---|---|---|---|---|---|---|---|---|
| | Extruder | Feed | 1^{st} Oil | EC1. | 2^{nd} Oil | EC1 | 3^{rd} Oil | EC1. |
| Example | rpm | Rate | Add | (wt %) | Add | (wt %) | Add | (wt %) |
| 1 | 470 | 28 g/min | 20 ml/min | 58.3% | 80 ml/min | 21.9% | 220 ml/min | 8.0% |

TABLE 2
Extruder Temperature Profile

| | | | | | | | | | |
|---|---|---|---|---|---|---|---|---|---|
| Feed | Feed | | 1st oil | | 2nd oil | | 3rd oil | | |
| Location | throat | | add | | add | | add | | |
| Barrell | 0 | 1 | 2 | 3 | 4 | 5 | 6 | 7 | Head |
| section | | | | | | | | | Flange |
| Temp. | 25 | 50 | 155 | 155 | 155 | 155 | 155 | 155 | 160 |
| Profile | | | | | | | | | |
| Setpoint (° C.) | | | | | | | | | |

Upon exiting the extruder the product was transferred to a belt cooler where it formed a ribbon that was approximately 4 cm wide and 0.8 cm thick. The belt cooler was 4.6 m long and was moving at a rate of 1.1 m/min. The temperature of the oleogel at different locations on the belt cooler is given in Table 3 as measured by an infrared thermometer.

TABLE 3
Temperature profile on belt cooler.

| Distance | | Measured Oleogel |
|---|---|---|
| Down Belt (m) | Time (sec.) | Temperature (° C.) |
| 0 | 0 | 120 |
| 0.3 | 17 | 100 |
| 1.2 | 68 | 60 |
| 4.6 | 237 | 40 |

### EXAMPLE 2

### Three Aqueous Dispersions from a Single Run

The oleogel made in Example 1 was combined with water and stearic acid to form aqueous dispersions as follows. As used herein, when particles of oleogel are dispersed in water in a composition that is at or above the gel temperature of the oleogel, the composition is referred to herein as an “emulsion.”

An oleogel phase was prepared by combining 1616 g of the oleogel from example 1 with 67.4 g stearic acid in a one gallon glass jar. The jar and its contents were then heated to 150° C. and mixed until uniform.

This oleogel phase was loaded into a Nordson Altablue 4TT hot melter where the reservoir and delivery line had both been preheated to 150° C. The oleogel was then pumped into a 5.08 cm (two inch) diameter rotor stator mixer heated to 150° C. and spinning at 900 rpm. The oleogel phase was merged at the mixer with a separate deionized water stream and a second aqueous stream of 30% wt. KOH to form a concentrated oleogel emulsion. The oleogel emulsion was passed to a second 5.08 cm (two inch) diameter rotor stator mixer heated to 125° C., where it was combined with an additional aqueous stream. All aqueous streams were fed by 500 ml Isco syringe pumps. The oleogel dispersion then passed through an exit tubing set to 90° C. and a backpressure regulator set to 446 kPa (50 psig), which kept the water in the process liquid at all times. The specific flow rates of the feed streams and properties of the resulting oleogel dispersions are shown in table 4.

Three samples of aqueous dispersion were collected from this procedure at three different exit temperatures, as shown in table 4, below.

### EXAMPLE 3

### Higher Solids Oleogel Dispersion

An additional run was performed with an oleogel phase made up of 940 g of the oleogel from Example 1 combined with 60 g of stearic acid as described above to generate an oleogel dispersion with a solids content of 85.6% by weight as shown in Example 3 of Table 4.

TABLE 4
Oleogel Dispersion Process Conditions and Properties

| | Example 2-1 | | Example 2-2 | | Example 2-3 | | Example 3 | |
|---|---|---|---|---|---|---|---|---|
| Oleogel phase | 16.8 | g/min | 16.8 | g/min | 16.8 | g/min | 15 | g/min |
| feed rate | | | | | | | | |
| Initial water feed | 1.0 | ml/min | 1.0 | ml/min | 1.0 | ml/min | 1.0 | ml/min |
| rate | | | | | | | | |
| 30% wt. KOH | 0.44 | ml/min | 0.44 | ml/min | 0.44 | ml/min | 0.44 | ml/min |
| (aqueous) feed | | | | | | | | |
| rate | | | | | | | | |
| Second water | 5.0 | ml/min | 7.0 | ml/min | 5.0 | ml/min | 1.5 | ml/min |
| feed rate | | | | | | | | |
| Exit temperature | 101° | C. | 89° | C. | 91° | C. | 92° | C. |

| | | | | |
|---|---|---|---|---|
| Solids Content | 69.6% | 64.8% | 71.2% | 85.6% |
| Vmean (μm) | 2.2 | 3.9 | 2.8 | 0.47 |
| D90 (μm) | 6.3 | 9.8 | 8.2 | 0.64 |

The resulting aqueous dispersions had good appearance. All were viscous, with shiny appearance, either slightly yellow or white.

### COMPARATIVE EXAMPLES 4C, 5C, 6C

Rotor Stator runs similar to Example 2 were performed using different dispersants, with the weight ratio of 96 parts by weight oleogel plus 4 parts by weight dispersant with the following results:

| Example | dispersant | result |
|---|---|---|
| 4C | 2 parts polysorbate | stable emulsion did not form; |
| | 80 plus 2 parts sodium | significant amounts of undispersed |
| | stearoyl lactylate | oleogel were present |
| 5C | 4 parts sodium stearoyl | stable emulsion did not form; |
| | lactylate | significant amounts of undispersed |
| | | oleogel were present |
| 6C | sodium stearate | not soluble in the melted oleogel; |
| | | did not act as dispersant |

### EXAMPLE 7

### Proposed Stable Emulsion Containing Polysorbate 80

It is contemplated that a stable dispersion could be made using a combination of potassium stearate (as described above) with polysorbate 80, then adding acid to reduce the pH of the dispersion. It is expected that, at the lower pH, the polysorbate 80 would stabilize the dispersed particles.

### EXAMPLE 8

### Replacement of Butter in Cookies

The following cookie recipes were used. Amount shown are weight percent.

| | Comparative | | |
|---|---|---|---|
| Ingredient | Example 8-1C | Example 8-2 | Example 8-3 |
| all purpose flour | 22.57 | 22.57 | 22.57 |
| whole rolled oats | 18.07 | 18.07 | 18.07 |
| light brown sugar | 17.09 | 17.09 | 17.09 |
| granulated sugar | 16.11 | 16.11 | 16.11 |
| fresh whole egg | 7.98 | 7.98 | 7.98 |
| butter | 16.72 | 8.36% | 0 |
| baking soda | 0.45 | 0.45 | 0.45 |
| salt | 0.45 | 0.45 | 0.45 |
| ground cinnamon | 0.34 | 0.34 | 0.34 |
| vanilla | 0.23 | 0.23 | 0.23 |
| inventive aqueous | 0 | 8.36 | 16.72 |
| dispersion | | | |

Butter (and/or inventive aqueous dispersion) at 23° C. was beaten with sugars in a mixer with paddle attachment for 2 minutes. Eggs and vanilla were added with continued mixing, followed by pre-blended flour, baking soda, salt, and ground cinnamon, with continued mixing for 2 minutes. Oats were added with continued mixing for 1 minute.

The resulting dough was shaped into balls and flattened, then baked for 10 minutes at 191° C. (375° F.).

Cookies made from all three recipes had similar appearance. All three formed cookies of desirable shape and color. Based on the feel and appearance of the cookies, the inventive aqueous dispersion appears to be an acceptable substitute for some or all of the butter.

### COMPARATIVE EXAMPLE 9C

### Demonstration of Gel Breakdown in Non-Dispersed Oleogel

Using the cup and stirrer apparatus described above for the test for gel temperature, 10 parts by weight of ETHOCEL™ STD 45 were mixed with 90 parts by weight of omega-9 canola oil. First, the ingredients were stirred at 25° C. at 1500 rpm for 5 minutes to form a solution. Two separate samples were made and tested, 9C-1 and 9C-2, as follows. The temperature profile was the same for both samples. In the table below, “increase” or “decrease” means that the temperature was increased or decreased at a constant rate versus time. “Rotation” and “oscillation” refers to the propeller motion. “Rotation” speed was 500 rpm. “Oscillation” mode refers to oscillation at 1 Hz and 0.5% strain.

| | | | PC-1 | PC-2 |
|---|---|---|---|---|
| Zone | Time (min) | Temperature | mode | mode |
| 1 | 0 to 5 | constant 25° C. | rotation | rotation |
| 2 | 5 to 35 | increase to 145° C. | rotation | rotation |
| 3 | 40 to 80 | constant 145° C. | rotation | rotation |
| 4 | 80 to 95 | decrease to 130° C. | rotation | rotation |
| 5 | 95 to 147 | decrease to 25° C. | oscillation | rotation |
| 6 | 147 to 177 | constant 25° C. | osclillation | oscillation |

Results were as follows: In zone 1, as temperature increased, both 9C-1 and 9C-2 showed gradual decrease in torque from approximately 300 μNm to approximately 80 μNm. In zone 2, both samples showed a relatively rapid rise in torque over the first 5 minutes, followed by very gradual increase to approximately 800 μNm. In zone 3, the torque remained level for both samples.

The behavior of 9C-1 in zones 4 and 5 was as follows. When 9C-1 entered zone 4, the mode switched from stirring to oscillation, and the torque dropped to approximately 0.2 μNM, which does not correspond to any physical change in the sample but only the change in measurement technique. The torque continued to fall gradually to approximately 0.1 μNm for approximately 10 minutes. Then, at approximately 100° C., the torque began to rise and continued to rise, with the rate of increase gradually slowing. In zone 5, with the temperature constant at 25° C., the torque was level at approximately 200 μNm. This behavior shows that as the solution cooled, a gel formed, which caused the oscillation torque to rise by over 1000× as the gel cooled.

The behavior of 9C-2 in zones 4 and 5 was as follows. Stirring mode was maintained throughout zone 4. In zone 4, as the temperature decreased from 130° C. to 115° C., the torque gradually decreased from approximately 800 μNm to approximately 450 μNm. Then, as the temperature decreased from 115° C. to 104° C., the torque increased steeply from approximately 450 μNm to approximately 1,300 μNm. Then as the temperature fell to 95° C., the torque fell to approximately 500 μNm and remained between approximately 400 μNm and approximately 600 μNm for the remainder of zone 4. In zone 5, the temperature as constant at 25° C. At the outset of zone 5, the mode switched from stirring to oscillation. The torque was constant at approximately 5 μNm. The increase in stirring torque at 115° C. shows that a gel formed at that temperature, and the very low oscillation torque at 25° C. shows that the continued stirring in zone 4 degraded or destroyed the gel structure, so that the 9C-2 behaved in zone 5 like a liquid rather than like a gel.

The behaviors of 9C-1 and 9C-2 is summarized in the following table:

| Zone | Temp. | 9C-1 mode | 9C-1 behavior | 9C-2 mode | 9C-2 behavior |
|---|---|---|---|---|---|
| 4 | 130° C. to | oscillation | gradual increase in | stirring | sudden increase in |
| | 25° C. | | torque | | torque at 115° C. |
| 5 | 25° C. | oscillation | torque ≈ 200 μNm | oscillation | torque ≈ 5 μNm |

As stated above, the behavior of 9C-1 shows that the oleogel forms as the solution cools and then behaves as a solid with very high torque at 25° C. In contrast, the behavior or 9C-2 shows that if the gel is subjected to stirring below the gel temperature, the gel will be broken and will have liquid-like behavior rather than solid-like behavior at 25° C.

### EXAMPLE 10

### Evidence of Lack of Breakdown Phenomenon in Dispersion of the Present Invention

As noted in Example 9, oleogel in the bulk form suffers a breakdown of the gel structure if subjected to mechanical shear. In contrast, the dispersion of the present invention does not suffer such breakdown. As evidence, the behavior of the dispersion described in Example 2 above is noted. The dispersion passes through a backpressure regulator without harm to the structure of the oleogel. The backpressure regulator subjects the dispersion to relatively high shear forces. It is considered that the shear forces imposed by the backpressure regulator are as high as or higher than those imposed by the stirring mode described in Example 9C above. It is contemplated that the dispersions responds to the shear forces by deformation of the aqueous medium, without imparting high shear forces to the dispersed particles of oleogel.

1. An aqueous dispersion comprising
(a) 5% to 40% of a continuous phase, by weight based on the weight of the aqueous dispersion, wherein the continuous phase comprises 75% to 100% water, by weight based on the weight of the continuous phase, and
(b) 60% to 95% of a distributed phase, by weight based on the weight of the aqueous dispersion, wherein the distributed phase comprises, by weight based on the weight of the distributed phase,
(i) 2% to 20% ethylcellulose polymer
(ii) 70% to 97% food oil
(iii) 1% to 10% dispersant.

2. The aqueous dispersion of claim 1, wherein the ethylcellulose polymer has ethoxyl substitution of 44% to 51%.

3. The aqueous dispersion of claim 1, wherein the food oil comprises one or more compound selected from the group consisting of milk fat, triglycerides extracted from plants, and mixtures thereof.

4. The aqueous dispersion of claim 1, wherein the dispersant comprises one or more fatty acid.
